(19) United States
(12) Patent Application Publication
(10) Pub. No.: US 2017/0039568 A1
(43) Pub. Date: Feb. 9, 2017

(54) Personalized and Dynamic Tokenization Method and System

(71) Applicant: NXT-ID, INC., SHELTON, CT (US)

(72) Inventors: David Tunnell, Palm Bay, FL (US); Charles Morgan, Katy, TX (US); Justin Mitchell, St. Cloud, FL (US)

(73) Assignee: NXT-ID, INC., SHELTON, CT (US)

(21) Appl. No.: 15/210,728

(22) Filed: Jul. 14, 2016

Related U.S. Application Data
(60) Provisional application No. 62/192,218, filed on Jul. 14, 2015.

(51) Int. Cl. G06Q 20/40; G06F 21/62; G06Q 20/38

(52) U.S. Cl. CPC G06Q 20/4014; G06Q 20/3829; G06Q 20/4016; G06F 21/6245; G06Q 2220/10

(57) ABSTRACT

Generating a dynamic secure token. The present invention showcases the local generation of a dynamic secure token that may have several predefined restrictions and/or attributes which can be easily verified by the recipient processing server, system, or device. In addition, the present invention can provide a secure token for any type of sensitive information that a user may desire to store on a device and securely verify/validate with another party, server, system, or device without disclosing the original sensitive information during the transmission of the secure token.

### CROSS-REFERENCE TO RELATED APPLICATIONS

This patent application claims priority to a provisional patent application filed on Jul. 14, 2015 and assigned Application No. 62/192,218, which is incorporated herein in its entirety.

### FIELD OF THE INVENTION

The present invention relates generally to systems and methods that use a token to represent private information (e.g., a financial account number), and more particularly to methods and systems that generate, deliver, encode, and/or encrypt dynamic secure tokens.

### BACKGROUND OF THE INVENTION

Prior art references typically use static-tokenization of account numbers for financial transactions.

US Published Patent Application 2012/0317036 entitled Payment Card Processing System with Structure Preserving Encryption uses static encryption of the user's primary account number for use in financial transactions.

U.S. Pat. No. 8,534,546 entitled Systems and Methods for Card Present Transaction Without Sharing Card Information discloses the use of a third-party static-token to be used in a financial transaction.

U.S. Pat. No. 8,954,758 entitled Password-less Security and Protection of Online Digital Assets uses simple, static encryption for accessing online assets.

U.S. Pat. No. 8,943,574 entitled Tokenizing Sensitive Data discloses static-tokenization of information based on a vendor-specific token/key and/or device-specific token/key.

U.S. Pat. No. 8,950,002 entitled Method and Apparatus for Token-Based Access of Related Resources uses a token to indicate approval for a transaction after successful authentication has occurred.

U.S. Pat. No. 8,943,322 entitled System and Methods for Authenticating and Electronic Transaction provides for the inclusion of a time-based, electronic signature to act as an authorization for in-application purchases to the distributer and/or developer.

U.S. Pat. No. 8,930,274 entitled Secure Payment Transactions with Rotating Application Transaction Counters allows for use of a challenge-response mechanism between the payment processor and the user's device to generate a token, which is then transmitted to the payment processor to execute a financial transaction.

U.S. Pat. No. 8,930,273 entitled System and Method for Generating a Dynamic Card Value discloses server-side (payment processor side) creation of a token to identify a user's financial account information.

U.S. Pat. No. 8,924,301 entitled Token Based Transaction Authentication provides tokens to authenticate a message channel between a payment device and a payment processor prior to the transmission of financial transaction messages and then to verify the content of those messages.

Prior art studies conclude that existing systems provide a static-tokenization of account numbers for financial transactions that either use the same token or use a single token from a small pool of tokens, for every transaction.

### SUMMARY OF THE INVENTION

This invention relates to systems and methods to securely conduct actions and/or transactions utilizing generated tokens to prevent public disclosure of the sensitive information required to execute those actions and/or transactions.

Under this invention, users have much greater protection against fraudulent access to their personal assets, devices, and systems as well as a strong defense against inadvertent disclosure of their sensitive information by a third party due to hacking, security breaches, or negligence. In addition to protecting the user's sensitive information, the secure tokens generated according to the present invention also protect the user from replay attacks (since according to some embodiments each token may be used only once), as well as providing for expiration of issued but not processed tokens. For example no observer could observe the tokenized PAN for one of the user's payment cards, and then use that PAN at a later time, as token expiration is measured in seconds.

A smart wallet, a wearable, and/or mobile device equipped with the software system capable of generating these secure tokens will go a long way to help fight both financial fraud and security breaches that are becoming commonplace in the current environment.

The present invention discloses generating and using a token for a variety of purposes, such as, but not limited to: authorizing payment from an account, gaining access to an access-controlled area, and gaining access to private information (e.g., sensitive information such as account numbers, sensitive personal information such as medical history, sensitive business information).

Accordingly, the present invention discloses a method and system whereby a user may conduct an action that requires an account number, membership number, alias and/or access code, using a token. The action can be completed using the token without disclosing the original account number, membership number, alias, or access code. This token is herein referred to as a “secure token.”

Use of the secure token to perform an action or execute a transaction avoids disclosing the sensitive account information, for example, thereby ensuring that the private nature of the account information is maintained.

The token may have certain characteristics such as a time sensitive constraint (e.g., one time use, limited number of uses, use limited to a given time interval, or use limited to within or outside of an identified geographic locale.

The token can be generated locally by a mobile device or a smart device, such as but not limited to a smart wallet, a wearable device, or a smart phone.

For example, a user who wishes to make a credit card purchase presents a credit card with a credit card chip to a reader. Alternatively, the credit card information can be presented using NFC, a Wi-Mag (wireless magnetic transmission), a magnetic stripe, EMV (EuroPay, MasterCard, Visa), tap-and-pay techniques and the like.

The device generates the secure token using information elements (time-of-day or location, for example) and the original static token issued by the bank. In either case the secure token is sent to the card-issuing bank, analyzed, and accepted. Acceptance notification is returned to the reader and the purchase price debited from the card account.

Note that secure tokens are only generated by a smart-wallet or smart-device (or other devices with a token generating capability) at the time of the transaction. When the user selects the account from which the payment is to be made, the token is generated using the information required by the conditions or constraints placed on that account. That data is setup to be read by the reader for immediate use and its validity period expires within a predefined period. This time period is sufficiently long to allow a waiter in a restaurant to carry the card to the point of sale terminal and swipe or insert the card in the reader.

In one embodiment of the invention, a user who wishes to conduct an on-line transaction presents the secure token in lieu of her conventional credit card number. If the secure token is accepted, the transaction is completed.

In another embodiment, a user who wishes to access a bank account for conducting an on-line balance review or money transfer between accounts presents the secure token in lieu of conventional log-in identification, PIN, password, etc. If the secure token is accepted, the user is automatically directed to his bank account ledger from which he can complete his review or conduct transfers.

In a similar embodiment of the invention, the secure token is associated with not only sensitive private information (an account number for example), but also with a specific user, i.e., use of the token not only executes a financial transaction but also authenticates the user. Such tokens that identify credentials or accounts, as well as the user, are referred to as a “personalized secure token” herein.

To create a personalized secure token, certain user-related or personal factors must be used in generating it. Such factors may include a user's location, a merchant name, an electronic device controlled or operated by the user, user biometrics (something you are), behavior-metrics (how you behave), knowledge-metrics (something you know) and/or device electronic-metrics (something you have).

Advantageously, according to this invention, a user can generate the secure token to represent more generally any private information, such as loyalty card numbers, credit card numbers, membership card numbers, etc. without worry that the private information (e.g., a credit card number) can be leaked to the public or stolen by a person accessing the secure token.

In one embodiment, the user can enroll (i.e., create a secure token for) one or more payment cards, ATM cards, gift cards, other financial cards, etc. on a device that creates the secure token. The secure token is used, in lieu of the credit card number, for example, to conduct a financial transaction, such as making a purchase using the credit card.

Preferably, the secure token has the same format as the characters it represents and therefore it is not necessary to modify a transaction-conducting device (a point of sale terminal for example). For example, the secure token has the same number of characters as the credit card number it represents.

### BRIEF DESCRIPTION OF THE DRAWINGS

FIG. 1 illustrates examples of factors used in creating a secure token.

FIG. 2 illustrates a process for initializing a device.

FIG. 3 illustrates a process in which a user enrolls or adds information to the device.

FIG. 4 illustrates the process in which the user enrolls her device with service providers, merchants, etc.

FIG. 5 illustrates a simplified version of generating a secure token using minimal information.

FIG. 6 illustrates a more complex version of generating a secure token using multiple rounds of format preserving encryption with various external data as encryption keys and/or salting values.

FIG. 7 illustrates the general process in which the user uses his or her device to conduct a financial transaction.

FIG. 8 illustrates generally how the processing server decodes the original secure token in order to link to the user's actual account for transaction authorization and execution.

### DETAILED DESCRIPTION OF THE INVENTION

Before describing in detail the particular methods and systems related to the generation (encoding) of the secure tokens and decoding of those tokens, it should be observed that the embodiments of the present invention reside primarily in a novel and non-obvious combination of elements and method steps. So as not to obscure the disclosure with details that will be readily apparent to those skilled in the art, certain conventional elements and steps have been presented with lesser detail, while the drawings and the specification describe in greater detail other elements and steps pertinent to understanding the embodiments.

The presented embodiments are not intended to define limits as to the structures, elements or methods of the inventions, but only to provide exemplary constructions. The embodiments are permissive rather than mandatory and illustrative rather than exhaustive.

This invention discloses systems and methods to generate, decode, and validate secure tokens and personalized secure tokens.

In some embodiments the secure token can be generated only on a local device (i.e., a device controlled by a user), or by a remote tokenization service that then sends the toke to a local device, in other embodiments. A processing server can then validate the token received from a local device.

After creating the secure token, the user can execute a transaction or perform an action related to sensitive or private information, such as, but not limited to financial account numbers using the secure token. The transaction or action is completed without jeopardizing the sensitive nature of the information, relying instead on use of the secure token.

A unique feature of this invention is the flexibility and security associated with generation and use of the secure token.

A token of the present invention may be generated based on one or more (in combination) of the following factors: an actual transaction account number, user biometrics (something you are), user secrets or knowledge-metrics (something you know), user behaviors or behavior-metrics (how you behave), device factors (something you have) or electronic-metrics. The device factors may include: a serial number, a device identification number, radio frequency emissions, electronic-metrics and proximity factors, as non-limiting examples.

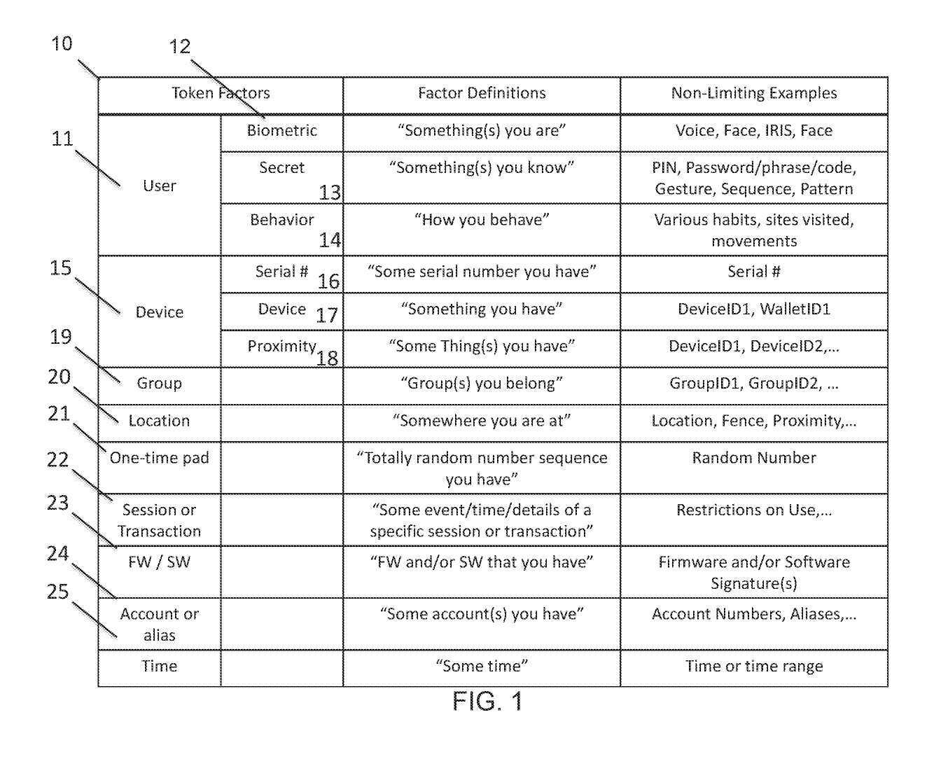

FIG. 1 sets forth several secure token factors or personalized secure token factors 10 that may be used to generate a secure token and/or a personalized secure token. These factors may relate to one or more of a user 11, device 15, group 19, location 20, one-time pad (OTP) 21 (a cryptographically-based encryption technique), session 22, transaction 22, firmware 23, software 23, an account alias 24, time 25, a brand, or sound.

For a personalized secure token for a specific user, the factors may also include, but are not limited to, personal information, biometrics, behavior-metrics, knowledge-metrics and electronic-metrics of a device used or controlled by the user.

Certain non-limiting examples of these factors are listed in FIG. 1: a biometric 12 (something you are), a secret 13 (something you know), or behavior or behavior-metric 14 (how you behave).

Whenever a user is operating or exercising control over a device, the process for creating a personalized secure token may also use device identifiers 15 (something you have), which may further include a device serial number 16, a device or electronic ID 17, an electronic-metric and/or proximity identifier 18 or the like.

Electronic-metrics are observable characteristics of a device that make it distinguishable from another device. Typically, these electronic characteristics are emissions, such as but not limited to electromagnetic fields (EMF). The electronic emissions are generated by circuitry of the electronics device and due to variations in circuit component parameters, thus making two otherwise identical devices distinguishable from each other. Electronic-metrics also comprise built-in unique IDs and proximity to other devices, which is detectible through other means, such as NFC, Bluetooth, Bluetooth Low Energy (BLE), WiFi, etc.

The use of personalized secure tokens allows simultaneous allows access to private information (accounts for example) and user authorization or authentication.

The second column of FIG. 1 defines the corresponding factor set forth in the first column. The third column lists examples of the factors.

With continued reference to FIG. 1, as an example, a secure token may be generated based on one or more of a serial number of a user-controlled device, an account number, a location, or a PIN.

In one embodiment, a user may enroll one or more of her financial accounts into a token-creating system. The system creates the secure token for the account that is then used in lieu of the financial account information, e.g., the account number, to access the account.

In various embodiments and applications, the secure token can be provided to various devices for transmitting the token. Those devices may include, but are not limited to: a card reading device, a POS (point of sale) terminal, a website, a network server, or any establishment agent.

Various communications systems may be used, including, but not limited to: NFC (Near Field Communications), Bluetooth, BLE (Bluetooth Low Energy), RFID (radio frequency identification), WiFi, 3G/4G/LTE, PAN (Personal Area Network), Barcode or QR Code, magnetic stripe, Wi-Mag (wireless magnetic stripe), acoustic signals, optical signals, radio frequency (RF) signals, and the like. Those skilled in the art are aware of other techniques that can be used to communicate with the secure token.

Manual token or card-carrying tokens entry techniques include, but are not limited to, a keyboard, a PIN-pad, and a sound or vocal utterance, motion behaviors and the like. Those skilled in the art are aware of other techniques that can be used.

In certain embodiments, the secure token is generated by an application executing on one or more of the following non-limiting exemplary devices: a smart wallet or watch, a mobile or portable computing device, a stationary workstation, a non-transitory computing device, or a wearable device (i.e., a wearable item with electronic components for performing one more functions embedded therein).

Since the token is generated according to a secure algorithm, the receiving entity must validate, authenticate and decode it. Every transmitted message, including tokens, must be validated to ensure that the message has not been tampered with (e.g., by man-in-the-middle attacks or transmission path corruption, etc.) and authenticated to ensure that it was transmitted from the presumed source. The decoded secure token may then link to the user's financial information, for example, to execute a financial transaction such as a purchase.

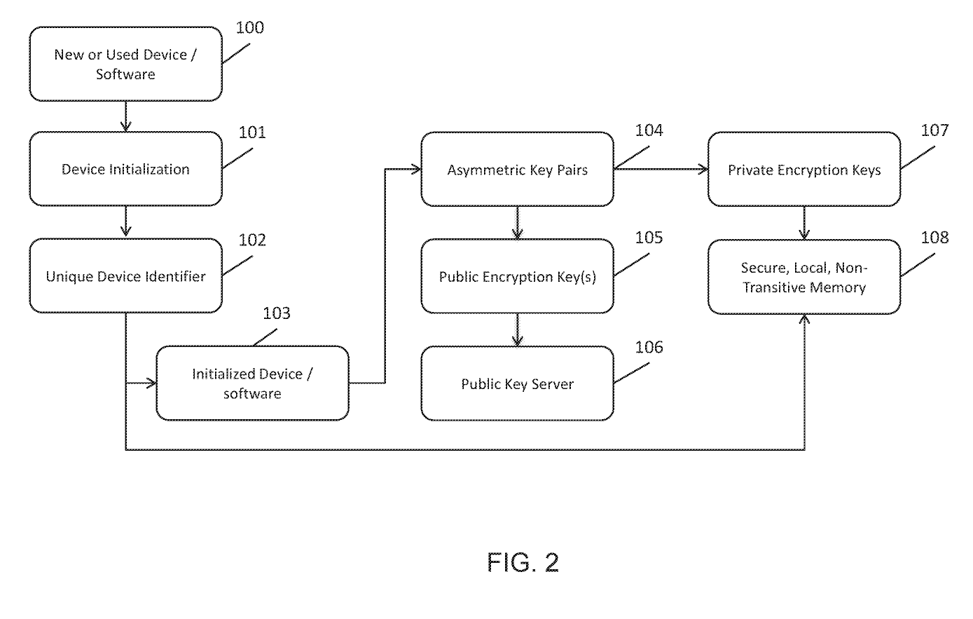

FIG. 2 illustrates device initialization. A new or used device or software 100, as non-limiting examples, is initialized at a step 101. At a step 102, a device identifier is created and securely stored in a local, non-transitive memory 108. The creation of multiple unique device identifiers will permit one or more users to use the device 100 in a secure fashion.

The identifier(s) 102 are stored in the memory 108 for later use in authorizing a user of the device 100.

After the unique device identifier(s) is generated and stored, the device is initialized at a step 103. Based on user input of unique factors (such as those set forth in FIG. 1) the initialized device generates an encryption algorithm (e.g., an asymmetric encryption key pair) at a step 104. Certain embodiments may permit the user to select certain variables and features of the encryption algorithm.

At a step 105 a public encryption key (an element of the asymmetric encryption key pair) is transmitted to a public key server 106.

The private encryption key 107 is stored securely in the memory 108 of the device 100.

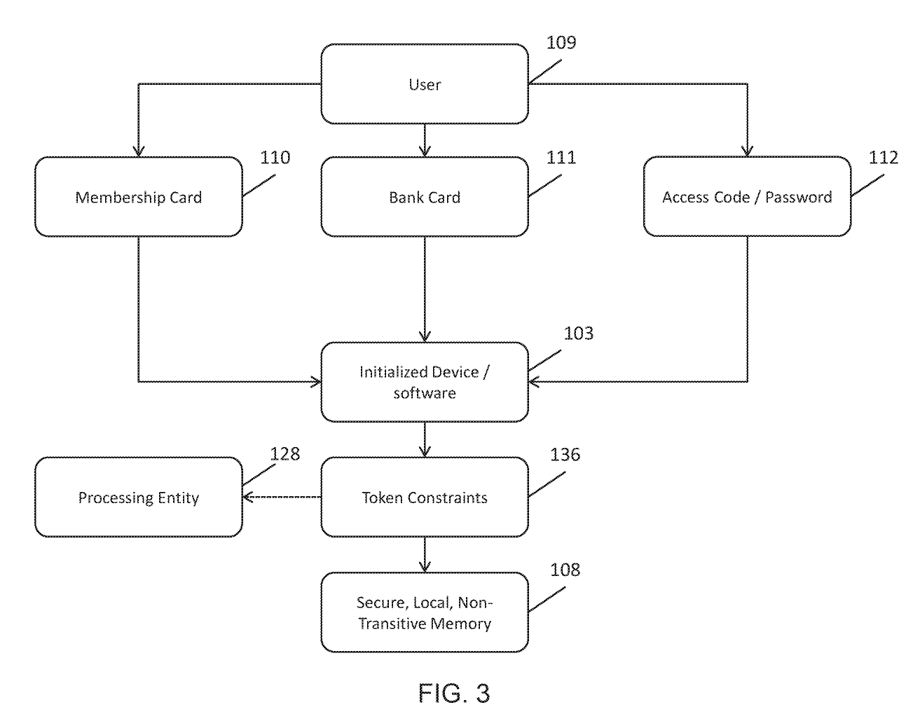

FIG. 3 illustrates a process, to be executed by a user 109, for enrolling private information (a credit card account number, for example) into the initialized device/software 103. The user may employ one or more of the following during the enrollment process: a keyboard, a touch screen, a PIN Pad, an application interface, and a web interface.

Non-limiting examples of sensitive or private information include: membership card information 110, bank card information 111, and access codes/passwords 112.

During enrollment, the sensitive information may be encrypted using one or more identifiers, such as those listed in FIG. 1, as factors.

Also during enrollment, the user may select token conditions, or constraints, or default constraints 136 to be associated with the secure token. These conditions may include time-sensitive tokens, location/area constraints (both permitted and prohibited, also referred to as blacklist locations/areas and whitelist locations/areas), merchants (both blacklist and whitelist merchants), and biometric factors (both biometric factors for authenticating a user and those that if identified will result in prohibiting the user from using the device 103).

The default settings may generate single-use tokens that are valid for a short period of time (less than 90 seconds for example). In other situations, a user may wish to use a token for recurring payments to a specific merchant in which case the generated token is personalized to that merchant. For instance, a user may wish to lock a token exclusively to the merchant (i.e., for use with the merchant) for which it was generated. The token is immediately deactivated if submitted from any other merchant, device, or system. This technique directly protects the user from unintended exposure of his financial account information if the merchant's servers and/or POS terminals were hacked, since this token could never be used by or for any other merchant or device.

The token can also be personalized to a specific user, location, device or the like.

These conditions or constraints are transmitted to a processing entity 128 when the user completes a registration process with the processing entity of a service provider, merchant, etc.

Note that the secure tokens are generated at the time the device 103 is used for payment of a purchase or is used to gain access. FIG. 3 depicts only registering information to be stored and constraints to be placed on its use. Those constraints can be in the form of SALT sources for the encryption process, for example, that are used when generating the secure token. These constraints are stored in the memory 108 and shared with the processor entity 128 (e.g., the credit card issuer) during the provisioning process.

During that provisioning process, the device 103 transmits information to the credit card issuing entity, the issuing entity associates the received information with the issued credit card, and issues a token back to the device 103. This token is used as base information to create the secure token of the present invention, which is created according to an algorithm, SALT sources, token constraints, etc.

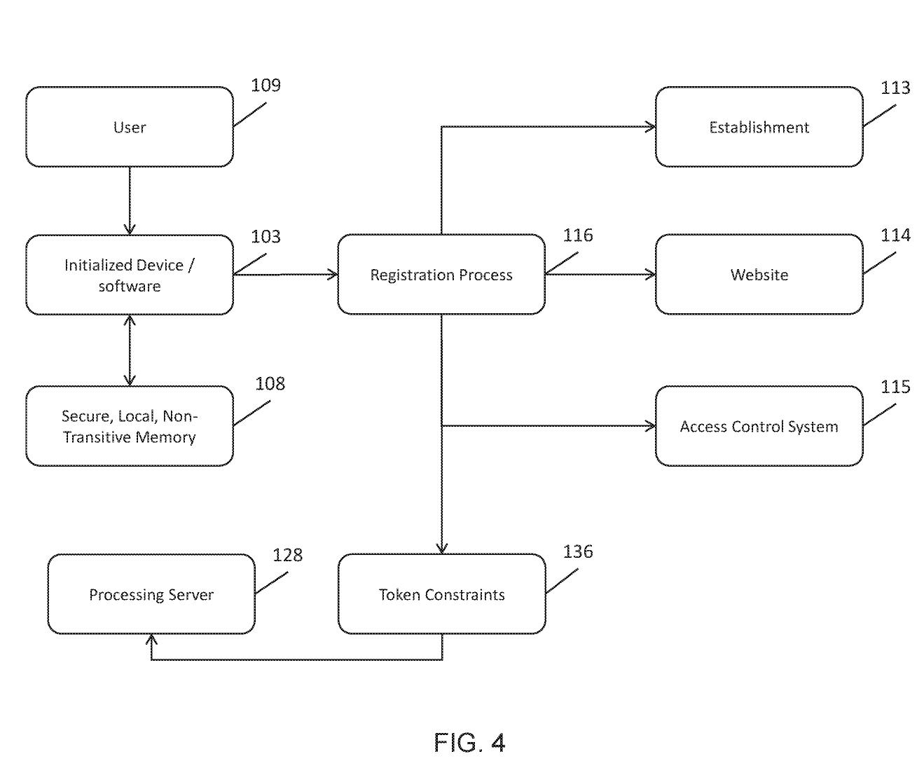

FIG. 4 illustrates a process for a user to register with an establishment 113, a website 114, and an access control system 115, for example, prior to using the device 103 to generate secure tokens for use with the establishment 113, the website 114, and the access control system 115.

During the registration process 116 the previously selected token conditions or constraints 136 are sent to the processing server 128. These conditions are verified by the processing server 128 when the secure token is decoded at the processing server. Any condition that is not met invalidates the secure token.

In certain embodiments, exceptions may be made to the default token constraints 136. For example, the user may create a secure token for a payment card that has a single condition of the merchant's name, the other default conditions not used. This non-limiting exemplary secure token may then be used for recurring or automatic payments to the designated merchant, and only to the designated merchant.

Other conditions that can be associated with a payment card may include time-locking and geographical location constraints (locale, range from a central point and inside/outside geo-fencing restrictions and the like).

However, situations may arise where certain exceptions to the default conditions or constraints must be recognized and accommodated. The risk factor concept associated with the present invention is a mechanism that allows for use of the secure token in when unexpected circumstances arise.

The user carries a VISA credit card with default constraints, including a geo-location constraint. But the user travels to a locale outside the geo-location constraint and makes a purchase. Without being able to accommodate possible exceptions that do not satisfy a token constraint, the purchase is refused.

But a token created according to the present invention may include a risk feature or factor, which allows for risk-based exceptions to token constraints that are not satisfied. For example, the user's device on which the token is stored can determine that it is “linked” to the vehicle's hands-free audio system and to the user's phone. The device therefore determines that although the geo-location constraint is not satisfied, there is some probability (relatively high in this situation) that the secure token is in the user's possession. This information or a probabilistic numerical value assigned to this situation is included with the secure token when it is transmitted to the card issuing authority. The card issuing authority evaluates the numerical value, determines that it is within a range of acceptable probabilities, and therefore approves the purchase, notwithstanding that it has occurred outside the geo-fence.

Certain constraint exceptions (outside the geo-fence, for example) or acceptable probability ranges that indicate the likelihood that the user is still in control of the token must be registered with the payment processor or card issuer during the provisioning process.

The default constraints define the acceptable requirements for use of the secure token, but the user can invoke additional alternative constraints that are operative when one of the default constraints is missing or not validated. In the scenario described immediately above, since the mandatory geo-location constraint is not validated, an alternative constraint is operative. An exemplary alternative constraint is the user (and his smart phone) are within 100 feet of his car as determined by an operative Bluetooth link between the smart-phone and the car audio system.

Other non-limiting constraints or conditions 136 may include payment methods, currency type, (e.g., crypto-currencies, such as “bitcoin”), a maximum permitted charge amount.

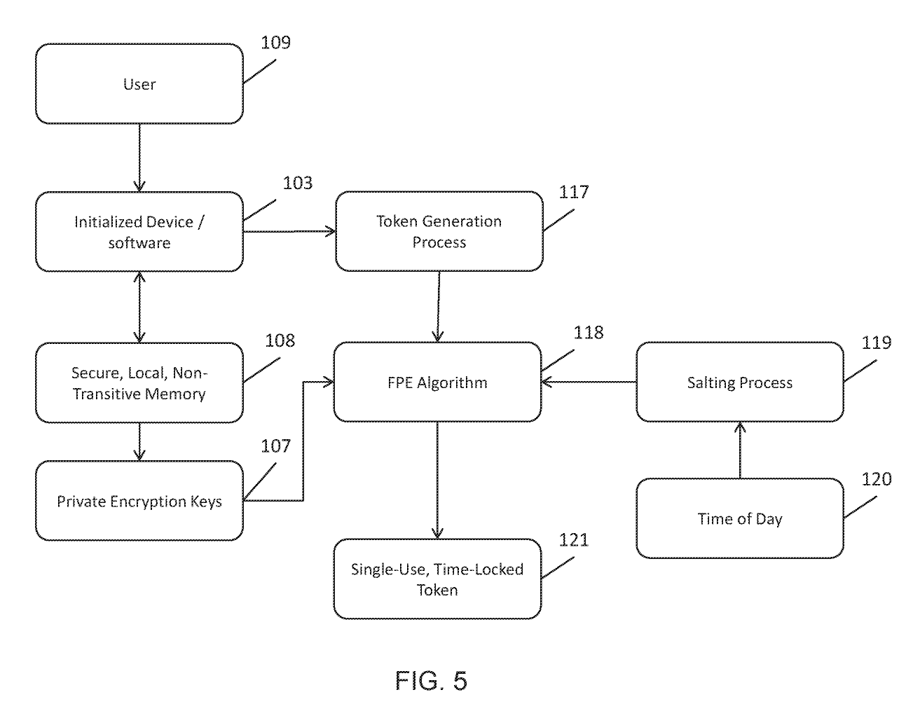

FIG. 5 sets forth a simple, non-limiting example of token generation. The user 109 uses his or her initialized device or software 103 to tokenize the information to be used for the action or transaction. For example, the user may select a payment account to be used. After authenticating the user and granting access, the initialized device 103 generates a secure token based on one or more of the token constraints or conditions described in conjunction with FIGS. 2 and 3, the user's private encryption key 107, and the information to be tokenized (account number for example) stored in the local, non-transient memory 108.

All of this data is then used to create the secure token. In the FIG. 5 embodiment an FPE (format preserving encryption) algorithm 118 is used. Details of the FPE algorithm are described below.

In addition, the algorithm may be modified according to a salting process 119, which is a cryptographic process for including an extra layer of security by hashing the data to be encrypted with the SALT value prior to executing the encryption process. In this non-limiting example, the time-of-day 120 is used as the salting value.

Non-limiting examples of other salting values that can be used include, but not limited to: a registered device identifier, proximity to other trusted/registered devices, geo-location, a PIN number, and the current time.

Based on the conditions applied for generating the secure token in this example, a single-use, time-locked secure token 121 is generated.

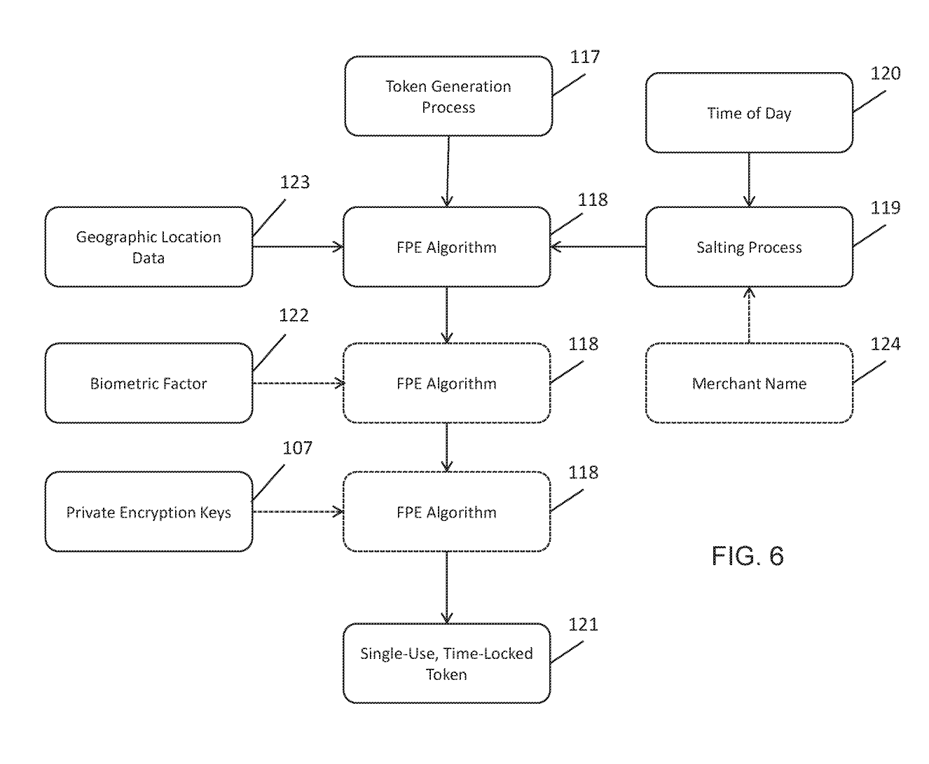

In FIG. 6, a more complex, non-limiting example of token generation is illustrated. During the token generation process 117, multiple rounds of the FPE algorithm 118 are used with each round using a different encryption key, including but not limited to the user's geographical location 123 (for round 1), a biometric factor 122 (for round 2) and the user's private encryption key 107 (for round 3).

The time of day 120, and/or merchant name 124 may also be used in conjunction with the salting process 119. In one non-limiting example, data to be tokenized is first salted using time of day 120 data and the merchant name 124 prior to executing through the three FPE algorithms 118.

This non-limiting example results in a secure token personalized to a specific merchant (block 124) protected with multiple rounds of FPE algorithm 118 for validation in which each layer must be validated in reverse order before the next layer can be validated.

The processing entity first safely retrieves the user's public key to perform the first decrypting layer for the token. Next the processing server verifies the factor supplied (biometric for example). If the result is affirmative, the second layer is decrypted. The processing entity then determines that the geographic location/area from which the token was submitted is whitelisted but not blacklisted, thus allowing decryption of the third token layer. Once the token has been fully decrypted, the salt-values can be subtracted from the token to completely decode the token.

Note that even at the last step of this example, when the salting values are being removed, if those salt values do not match values expected by the processing server, a valid token cannot be be decrypted from the secure token.

In another non-limiting exemplary method of the present invention, the FPE and/or hashing function is salted with one or more risk scores generated from an authentication session between one or more devices and/or one or more users. Such risk scores are produced based on one or more authentication methods.

In some embodiments, risk scores may be derived from one or more inputs including but not limited to at least one of a biometric, a knowledge-metric, a behavior-metric, or an electronic-metric input. In still other embodiments, a combination of inputs may be cumulatively utilized to produce the final risk score used for hashing. Risk scores may also include but are not limited to integer, letter, or symbolic values. Herein, the token is not only validated by salting of the risk score, but the inherent risk level represented by the score may be used to determine the degree of the token's acceptance. As in one non-limiting example, a token may contain a risk score that may be validated by the receiving party; however, the token could still be rejected if the value of the risk score is below a pre-determined value or outside a predetermined range.

Additional details of risk score concepts and their use in determining a degree of confidence in data exchanges and authentication are described in co-owned patent application assigned application Ser. No. 14/217,202 filed on Mar. 17, 2014 and entitled, The “UnPassword™: Risk Aware End-to-End Multi-Factor Authentication via Dynamic Pairing and another application of the same title filed on Mar. 14, 2016 and assigned application Ser. No. 15/068,834. Both of these applications are incorporated herein in their entirety.

Another embodiment of the present invention entails separating an account number, for example, into two or more segments for the purpose of encrypting, hashing, and/or salting each segment separately. In some embodiments one or more segments may be encrypted, hashed, and/or salted differently from one or more other segments. Different segments may be salted using different data elements including but not limited to device ID, location, a private asymmetric encryption key, time of day, merchant name, and/or a biometric factor. Each segment may also embody different constraints or conditions.

In one non-limiting example one segment of an account number may be hashed and salted with a risk score produced from a biometric input, while the other segment may be hashed and salted with numerical values representative of geometric coordinates.

In some embodiments, two or more of the segments may be combined into a single token and then encrypted. Upon receiving the secure token, the one or more receiving endpoints or receiving devices may decrypt the token and then separate the token into its segments using one or more algorithms at the receiving end. These two segments may then be mapped and/or decrypted back to the original segments to reveal the account number. Once the two segments are determined relative to the original characters of the account number, each segment may then be assembled using one or more algorithms to form the complete original card number.

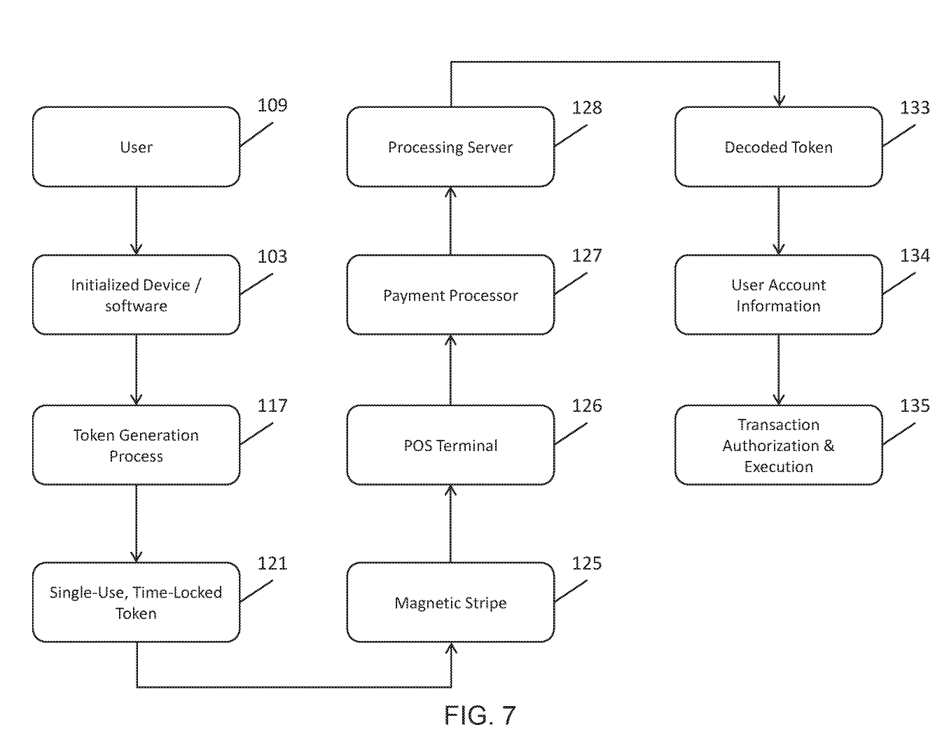

FIG. 7 describes a general, process flow that includes certain features of the present invention. The user 109 authenticates himself to the initialized device 103 to execute a transaction. After a payment method is selected (or more specifically a communications technique for effecting the payment method is selected), the initialized device/software 103 executes the token generation process 117 whereby a secure token 121 is produced. The token generation process has been described above.

In some non-limiting embodiments, the secure token or personalized secure token may be temporarily recorded to a magnetic strip 125. The magnetic strip may then be swiped on a POS terminal 126 just as a conventional payment card is swiped.

The token and other information are delivered to one or more payment processors 127 via a network connection, which in turn delivers this information to one or more processing servers 128 capable of decrypting and decoding the secure token. The resultant decoded token 133 is then delivered to the financial institution that issued the account to the user. There the secure token is used to lookup and identify the user's actual account information 134. Once this step is completed, the issuing financial institution authorizes and executes the transaction 135.

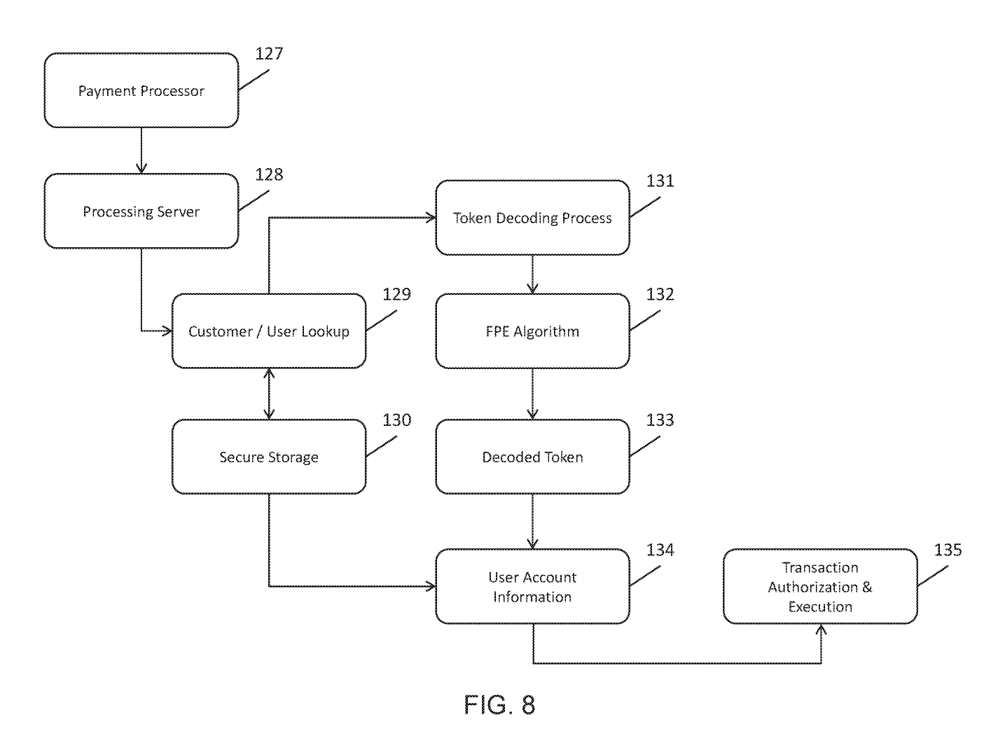

FIG. 8 describes a simplified, non-limiting example of the processing server 127 decoding the secure token of FIG. 7. When the payment processor 127 receives the secure token and additional non-sensitive data from the POS terminal, it treats the data like data associated with any other incoming transaction by delivering the information to a processing server 128.

Using the received data, the processing server 128 recognizes that the user has registered a device capable of producing secure tokens and at a step 129 the user's public encryption key is retrieved from a key server and/or from secure storage 130. This public key and/or other identified token condition/constraint data is supplied to the token decoding process 131 wherein the FPE algorithm 132, for a non-limiting example, decrypts the token, removes and validates any salting values, that results in a decoded token 133.

The decoded token 133 is then used to lookup the user's account information 134. Once the account and the user have been verified, the issuing financial institution authorizes and executes the transaction (e.g., processes the payment transaction).

There are numerous other examples to describe the present invention as it pertains to personalized tokenization and/or account and/or membership numbers and/or access codes. In these embodiments, when the secure token is completely decoded, it results in the original sensitive information enrolled into the initialized device. In some instances, this sensitive information can be an alias to actual account/membership numbers and/or access codes, or in some embodiments, some identifier of a user, a device and/or an entity.

As a non-limiting example of one such embodiment, when a user wishes to enter her office building using her initialized device, she selects the access code needed by an alias name, the device displays a generated secure token code instead of the alias name. The user then enters this token code into the PIN pad on the door or security system. The access control system decrypts the token, producing a valid access code for the door or security system.

Certain embodiments of the invention employ format-preserving encryption (FPE) where the format of the secure token has the same format as the information (account identifier for example) that it represents. This feature avoids the need to change or modify operation or input mechanisms of any device operative both an account identifier (conventional use) and with a secure token.

In some embodiments format-preserving encryption (FPE) is utilized for generating the secure token to preserve the length and character-set of the original sensitive information.

In some embodiments the FPE and/or hashing function is salted with an integer representation of the current Coordinated Universal Time (UTC) to produce a one-time-use, time-sensitive token that is valid for only a specific period of time.

In other embodiments the FPE and/or hashing function is salted with an integer value from a counter that was initialized with a random value at the same time the application was initialized. This technique produces a one-time-use, non-time-locked token.

In some embodiments the FPE and/or hashing function is additionally salted with an integer representation of the current geographical location or area to produce a secure token that is only valid when created at predefined locations and thus is valid only when used at these predefined locations.

In some embodiments, the FPE and/or hashing function is salted with the merchant name or an integer representation thereof, to produce a token that is valid only when used to conduct a transaction with that merchant.

In some embodiments, the FPE and/or hashing function can be additionally salted with an identifier associated with the device on which the token is being generated. This technique produces a token that is valid only when used in conjunction with that specific device.

In other embodiments, the FPE and/or hashing function can be additionally salted with the integer representation of a user identifier, such as but not limited to biometric factor, electronic-metric, knowledge-metric, or behavior metric so as to produce a token that is only valid when the transaction is authorized/executed by the user or an agent preauthorized by the user. Herein this feature is referred to as a personalized secure token.

In other embodiments, the FPE and/or hashing function is salted with an integer representation of a cumulative risk analysis score known by each device (i.e., each device at an endpoint of the transaction) to produce a token that is valid only between these two devices. This risk score not only further encodes the token, but also identifies risk associated with the action or transaction, thereby allowing each of the endpoint devices to determine if the risk level is acceptable for carrying out the action or transaction.

Some embodiments of the present invention utilize a technique wherein a card number is divided into a plurality of subgroups. The individual groups are then each individually hashed and salted, producing tokens representative of segments of the entire card number.

In some embodiments external data (i.e., external in the sense that it is not associated with the action or transaction), including but not limited to a device identifier, an electronic-metric, a time of day, a location, a store, a merchant name, a behavior-metric, a knowledge-metric, and/or biometric, re-encrypts a previously generated secure token. This technique is distinguished from a technique wherein external data is used as a salting value during the initial encryption.

In some embodiments, the method and system of the invention comprises receiving a generated secure token at a transaction entity where a server of the entity ascertains the validity of the token by: (i) decoding the token based on predefined public keys and salting sources; (ii) validating the salting value(s) against external data, (e.g., current time (UTC), approved locations, approved stores, approved merchants, registered device identifiers, registered biometric factors); (iii) if the token is validated, which actually occurs when the token is decoded, the resulting access identifiers are then compared with users' information in a database and if a match occurs the transaction or requested action is executed.

In another embodiment or application, a secure token is received by a controlled access device that decodes the token by: (i) decrypting the token using a registered public key for the user and a predetermined salting source to determine an access character; (ii) the access character authenticates the user's access to the controlled access device.

Once a card is registered and provisioned by the issuing party, as described herein, use of the “token” and “card” and “account” in the context of the present technical description are synonymous and used interchangeably.

Generally, in the context of the present application references are made to secure tokens and personalized secure tokens. The latter token types are associated with or embed personal characteristics of the user or a device operated by the user. Also, constraints, conditions, SALT values, and/or private encryption key(s) can be used personalize the token, thereby creating a personalized secure token.

Generally, in the context of the present invention references are made to hashing functions, format-preserving encryption algorithms, and other forms of algorithmic encryption. As those skilled in the art are aware, these terms are essentially interchangeable as applied to the present invention, as each is essentially a cryptographic function that maps private input data to output data, wherein the input data cannot be easily determined from the output data.

An exemplary system for implementing the various software aspects of the invention includes a computing device or a network of computing devices. In a basic configuration, computing device may include any type of stationary computing device or a mobile computing device. Computing device typically includes at least one processing unit and system memory. Depending on the exact configuration and type of computing device, system memory may be volatile (such as RAM), non-volatile (such as ROM, flash memory, and the like) or some combination of the two. System memory typically includes operating system, one or more applications, and may include program data. Computing device may also have additional features or functionality. For example, computing device may also include additional data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules or other data. System memory, removable storage and non-removable storage are all examples of computer storage media. Non-transitory computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other physical medium which can be used to store the desired information and which can be accessed by computing device. Any such computer storage media may be part of device. A computing device may also have input device(s) such as a keyboard, mouse, pen, voice input device, touch input device, etc. Output device(s) such as a display, speakers, printer, etc. may also be included. Computing device also contains communication connection(s) that allow the device to communicate with other computing devices, such as over a network or a wireless network. By way of example, and not limitation, communication connection(s) may include wired media such as a wired network or direct-wired connection, and wireless media such as acoustic, RF, infrared and other wireless media.

Computer program code for carrying out operations of the invention described above may be written in a high-level programming language, such as C or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller. A code in which a program of the present invention is described can be included as a firmware in a RAM, a ROM and a flash memory. Otherwise, the code can be stored in a tangible computer-readable storage medium such as a magnetic tape, a flexible disc, a hard disc, a compact disc, a photo-magnetic disc, a digital versatile disc (DVD). The present invention can be configured for use in a computer or an information processing apparatus which includes a memory, such as a central processing unit (CPU), a RAM and a ROM as well as a storage medium such as a hard disc.

The “step-by-step process” for performing the claimed functions herein is a specific algorithm, and may be shown as a mathematical formula, in the text of the specification as prose, and/or in a flow chart. The instructions of the software program create a special purpose machine for carrying out the particular algorithm. Thus, in any means-plus-function claim herein in which the disclosed structure is a computer, or microprocessor, programmed to carry out an algorithm, the disclosed structure is not the general purpose computer, but rather the special purpose computer programmed to perform the disclosed algorithm.

A general purpose computer, or microprocessor, may be programmed to carry out the algorithm/steps of the present invention creating a new machine. The general purpose computer becomes a special purpose computer once it is programmed to perform particular functions pursuant to instructions from program software of the present invention. The instructions of the software program that carry out the algorithm/steps electrically change the general purpose computer by creating electrical paths within the device. These electrical paths create a special purpose machine for carrying out the particular algorithm/steps.

Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Biometric inputs as referred to herein may comprise any one or more of a fingerprint, a hand print, a voice input, an audio input, an iris print, voice pitch, dimensions of a body part, facial characteristics, an electrocardiogram, heart rate, and a scent, etc.

Behavioral-metric inputs as referred to herein may comprise any one or more of a pose, a position, a rotation, a hand gesture, a facial expression, a facial position, a facial movement, a body position, an eye blinking rate, a number of eye blinks, a body motion, a vocal utterance, an aural utterance, motion of an object, position of an object, a drawn pattern, a time interval between two behavioral-metric inputs, induced vibrations, duration of a behavioral-metric input, motion speed, motion acceleration, motion velocity, direction of motion, a hand motion, time elapsed during the hand motion, a static gesture, one or more sign language letters or characters, and a rhythmic input, etc.

Electronics-metric inputs as referred to herein may comprise any one or more of an electro-magnetic field, an emission having features distinctive to an electronic device, a noise spectrum as a function of frequency, an amplitude spectrum as a function of frequency, a pulse width, a power level as a function of frequency, emissions generated by a switching circuit, and RF connection/communication proximity to other electronic devices.

Knowledge-metric input as referred to herein may comprise any one or more of a password, a personal identification number, a login characters, a response to a question, a tap, and a personal identification number, etc.

While the invention has been described with reference to preferred embodiments, it will be understood by those skilled in the art that various changes may be made and equivalent elements may be substituted for elements thereof without departing from the scope of the invention. The scope of the present invention further includes any combination of the elements from the various embodiments set forth herein. In addition, modifications may be made to adapt a particular situation to the teachings of the present invention without departing from its essential scope.

What is claimed is:

1. A method for generating a secure token to be used in lieu of a private access identifier to gain access to an access-controlled region, an access-controlled device, or access-controlled information, the method comprising:
storing the private access identifier on a user device;
storing conditions related to use of the secure token on the user device;
the user device receiving user characteristics for authenticating a user to the user device; and
generating a secure token based on one or more of the private access identifier, the conditions, and the user characteristics.

2. The method of claim 1 wherein the access-controlled information comprises private information, sensitive personal information, sensitive business information and sensitive medical information.

3. The method of claim 1 wherein the private access identifier is subdivided into two or more private access identifier segments and the step of generating comprising generating a secure token for each segment.

4. The method of claim 3 wherein a different salt process, a different hash process, or a different encryption algorithm is used for each one of the two or more private access identifier segments.

5. The method of claim 1 wherein the step of generating comprises generating the secure token by using one or more of a format preserving encryption algorithm, a salting process, and a hashing process.

6. The method of claim 5 wherein salting process values for use during the salting process comprise one or more of a public encryption key, a private encryption key, an electronic-metric for the user device, a payment account number, a personal account number, a current time, a merchant identifier, a geographical location, an identifier for the user device, a user biometric factor, a user knowledge-metric factor, a user behavior metric factor and a risk score.

7. The method of claim 1 wherein the access-controlled region comprises a computer, a network, a system, an application, an office, a building, a car or a safe.

8. The method of claim 1 wherein the user device comprises a tamper-proof user device further comprising a secure memory or a non-transitory memory for storing the private access identifier.

9. The method of claim 1 wherein the private access identifier is supplied to the user device without use of network connectivity.

10. The method of claim 1 wherein the private access identifier is not determinable from the secure token.

11. The method of claim 1 wherein to gain access to the access-controlled region, the access-controlled device, or the access-controlled information, the secure token is supplied to a token processor storing token conditions, wherein if conditions included within the secure token during the generating step match stored token conditions at the token processor, and the user is authenticated by the token processor, the user is granted access to the access-controlled region, the access-controlled device, or the access-controlled information.

12. The method of claim 11 wherein the user is granted access if a variance between conditions included within the secure token during the generating step and the stored token conditions is within a predetermined variance range.

13. The method of claim 1 wherein to gain access to the access-controlled region, the access-controlled device, or the access-controlled information, the secure token is presented to any one or more of card reading device, a point of sale terminal, a website, a network server, and an establishment agent.

14. The method of claim 1 wherein the secure token resides on a card or on a communications device, and wherein the card or the communications device communicates the secure token to a receiving device via any one or more of near-field communications, Bluetooth, Bluetooth Low Energy, radio frequency identification, WiFi, 3G, 4G, LTE, a Personal Area Network, a barcode, a QR code, a magnetic stripe, wireless magnetic stripe, an acoustic signal, an optical signal, and an audio frequency signal.

15. The method of claim 1 executed on a smart wallet, a smart watch, a mobile device, a portable device, a smart phone, a personal computer, a laptop computer, a tablet computer, a dongle, a server, a stationary workstation, a computing device, or a wearable device.

16. The method of claim 1 the secure token further comprising a risk factor.

17. The method of claim 16 the step of generating comprising use of a salt process, the risk factor used in the salt process.

18. The method of claim 16 the secure token provided to a token processing entity, the risk factor considered at the token processing entity in granting or denying access.

19. The method of claim 16 the risk factor determined responsive to an authentication process executed for a user of the user device.

20. The method of claim 1 further comprising the secure token received, validated, authenticated, decoded and processed at one or both of a payment processor and a token processor.

21. The method of claim 1 wherein the secure token is associated with a user's payment transaction and supplied to a payment processor, the payment processor processing the secure token by sending the secure token to a financial institution that executes the payment transaction responsive to the secure token declared valid.

22. The method of claim 1 wherein the user device comprises any one of a portable device, a mobile device, a smart phone, or a smart wallet.

23. The method of claim 1 wherein the conditions comprise one or both of default token use constraints and user-defined token use constraints.

24. The method of claim 23 wherein the default token use constraints or the user-defined use constraints comprise any one or more of, use limited to a geographical region, a use limited to a payment method, a use limited to a currency type, a use limited to a time of day, a use limited to a time interval, a predetermined number of uses of the secure token, a use limited to financial transactions with one or more specified merchants, a use limited to a single use, a use limited to a maximum value for a transaction, a use having an expiration date, and a use limited to a single use that expires at predetermined time from generation of the secure token.

25. The method of claim 23 wherein the secure token is salted with one or more constraints selected from the default token use constraints and the user-defined token use constraints.

26. The method of claim 1 wherein if a user of the token is not authenticated, access to the access-controlled region, the access-controlled device, and the access-controlled information is denied.

27. The method of claim 1 wherein the conditions comprise an identifier associated with the user device.

28. The method of claim 27 wherein the identifier comprises any one or more of a user device serial number, an electronic identification, an electronic-metric, a proximity identifier, and an identifier derived from characteristics of a field emitted by the user device.

29. The method of claim 1 wherein the access-controlled information comprises an account number, a loyalty card number, a credit card number, a membership card number, a payment card number, an ATM card number, a bank card number, a debit card number, an access password, and an access code,

30. The method of claim 1 wherein information carried by the secure token is set forth in a first format and the private access identifier is set forth in a second format, wherein the first and second formats are identical.

31. The method of claim 30 wherein the first and second formats comprise a same character length and a same character set.

32. A user device for generating a secure token for use in conducting a transaction, the secure token used in lieu of an account identifier associated with the transaction, the user device comprising:
a memory component for storing one or more token condition factors;
an input component for receiving one or more user authentication factors; and
a user device processor for generating the secure token responsive to the token condition factors, the secure token including the authentication factors.

33. The user device of claim 32 wherein the token condition factors comprise a predetermined validity period, and a predetermined validity locale.

34. The secure token generated by the user device of claim 32 supplied to a token processor for conducting the transaction if the token is determined to be a valid token and the user is authenticated to the user device.

35. The user device of claim 34 wherein the token processor decodes the secure token, validates the secure token relative to any salting values associated with the secure token, wherein if the secure token is validated and the user is authenticated, the token processor determines the account identifier for conducting the transaction and executes the transaction.

36. The user device of claim 32 wherein the user authentication factors comprises any one or more of a biometric, a knowledge-metric, and a behavior-metric.

37. The user device of claim 32 comprising a smart wallet, a smart watch, a mobile device, a portable device, a smart phone, a personal computer, a laptop computer, a tablet computer, a dongle, a server, a stationary workstation, a computing device, or a wearable device.

38. The user device of claim 32 the secure token comprising any one or more of a one-time secure token and a time-sensitive secure token.

39. The device of claim 32 wherein the token condition factors. comprise a user location, a merchant identifier, and identification indicia for the user device.

40. A user device for generating a secure token for use in making a payment for a purchase, the secure token used lieu of an account identifier associated with the payment, the user device comprising:
a memory component for storing one or more token condition factors;
an input component for receiving one or more user authentication factors; and
a user device processor for generating the secure token responsive to the token condition factors, the secure token including the authentication factors.

41. The secure token generated by the user device of claim 40 supplied to a token processor for making the payment if the token processor validates the secure token relative to any salting values associated with the secure token, wherein if the secure token is validated and the user is authenticated, the token processor determines the account identifier for use in making the payment and makes the payment.

42. The user device of claim 41 wherein the token is validated if the token conditions associated with the secure token match stored token conditions stored at the token processor and if the user is authenticated to the user device.

43. The user device of claim 40 wherein the payment is made if a variance between token condition factors and stored token conditions as stored at a payment processor is within a predetermined variance range.

44. The user device of claim 40 wherein the device processor generates the secure token using one or more of a format preserving encryption algorithm, a salting process, and a hashing process.

45. The user device of claim 40 wherein the account identifier is not determinable from the secure token.

46. The user device of claim 40 wherein to make the payment the secure token is presented to any one or more of card reading device, a point of sale terminal, a website, a network server, and an establishment agent.

47. The user device of claim 40 the secure token further comprising a risk factor determined responsive to an authentication process executed at the user device, the risk factor based on any difference between the user authentication factors received by the input component and stored authentication factors of legitimate users of the user device.

48. The user device of claim 40 the secure token provided to a token processing entity, a risk factor considered at the token processing entity in making the payment, the risk factor responsive to an authentication process of a user of the user device.

49. The user device of claim 40 comprising any one of a smart wallet, a smart watch, a mobile device, a portable device, a smart phone, a personal computer, a laptop computer, a tablet computer, a dongle, a server, a stationary workstation, a computing device, or a wearable device.

50. The user device of claim 40 wherein the token condition factors comprise one or both of default token use constraints and user-defined token use constraints.
